(19) United States
(12) Patent Application Publication
(10) Pub. No.: US 2014/0306893 A1
(43) Pub. Date: Oct. 16, 2014

(54) Computer Pointing Device based on Hand/Foot Directional Pressure

(71) Applicant: Rashed Siddiqui, (US)

(72) Inventor: Rashed Siddiqui, Boca Raton, FL (US)

(21) Appl. No.: 14/251,478

(22) Filed: Apr. 11, 2014

Related U.S. Application Data
(60) Provisional application No. 61/810,897, filed on Apr. 11, 2013.

(51) Int. Cl. G06F 3/0354

(52) U.S. Cl. CPC G06F 3/03543; G06F 2203/0332
USPC 345/163

(57) ABSTRACT

The present invention describes the concept of a computer display pointing and clicking device which does not require a sliding movement of the mouse on the table top or a surface to navigate a cursor on the computer screen. In another version, the device does not even require the movement of the fingers for clicking. Instead the hand is stationary situated on the top of the mouse without any major movements. The pressure of the hand on the device causes the cursor on the screen to move, and as the user's hand leans to different directions fluctuating the pressure on the four sides of the mouse, the cursor moves towards the corresponding side. In yet another version, mere twisting pressure in a counterclockwise or clockwise direction implements the left-click and right-click button functionality of a standard mouse.

### CROSS REFERENCE TO RELEVANT EXISTING ART

A cursory internet search did not produce any similar ideas or concepts.

### FEDERAL GRANTS AND SPONSORSHIP

This invention and its entire development is managed and funded by private inventors and never connected to any Federal or State grants and/or sponsorship.

Normal computer pointing devices, such as optical/mechanical mice, trackballs, joysticks, touch pads, track sticks, navigation buttons, or any other devices available in the market, all require full control of the hand-muscles. The main concept of the present invention lies in that it does not require any significant limb movements. This could be suitable for normal use or for use by people with special needs. Some people with special needs may not have full control on the muscles of their arms, hands, and/or figures, and therefore full navigation of normal pointing devices may not be comfortable or even possible in certain cases. The advantage of the present invention is in that it does not require the full control of the user's arm, hand, and/or fingers. It requires minimal movement or orientation of the hand resting on the device, which will be ideally suited for many people with such special need. The left/right clicks can still be achieved by means of the normal left and right click buttons as in the normal mouse, or in this new invention they are recognized by merely twisting the hand orientation to left/right while keeping relative pressure on the four sides unchanged.

It is important to understand that the disclosed concept extends to a foot-based pointing device where the foot is placed on the top of the floor-placed device which senses the relative pressure on the four sides and determines the cursor movement based on the corresponding side and direction experiencing increasing pressure. The left/right clicks are recognized by twisting the foot orientation to left/right while keeping relative pressure on the four sides unchanged.

### SUMMARY OF THE INVENTION

In one embodiment of the invention, an ergonomic design is used to fit the limb being used whether left or right hand or foot. It can accommodate a pair of regular mouse buttons to achieve the regular left or right click functionality provided in most computer operating systems. The core movement functionality is implemented by a device having a stationary base that is generally affixed to a desk or table top, and is conjoined to a slightly movable top part via a pressure sensor assembly which registers pressures instead of full movement, and is sensitive to relative pressures and directions to implement the up/down motion of the cursor by exerting pressure towards the front or rear of the device.

In another embodiment of the invention, the pressure assembly has four single dimensional pressure sensors, two of them mounted on the opposing front and rear sides of the assembly, and the other two mounted on the opposing right and left sides of the assembly, along with a single twist sensor mounted in the middle of the assembly to measure a twist by the user either clockwise or counter-clockwise. Such a twist is then implemented as a right-click for clockwise and as a left-click for counterclockwise.

In yet another embodiment of the invention, the pressure assembly has six two-dimensional pressure sensors, two of them mounted on the opposing front and rear sides of the assembly, and the other four mounted two each on the opposing right and left sides of the assembly, so as to be able to measure a twist by the user either clockwise or counter-clockwise and by measuring the pressure as positive or negative along an x-axis for the four left and right side sensors (left direction is negative, right is positive) and along a y-axis for the front and rear side sensors. Where all four register a positive (right) relative pressure or negative (left) relative pressure, the cursor movement is in the respective direction. On the other hand when the relative pressures registered differ between the two front (left and right) sensors on one hand and the two rear (left and right) sensors on the other, it is treated as a twist and thus as a click. When the front two sensors register positive pressure (right) and the rear two negative (left), it is a clockwise twist which is interpreted as a right-click. However, if the front two sensors register negative (left) and the rear two positive pressure (right), it is a counterclockwise twist which is interpreted as a left-click.

In yet another embodiment of the invention, the pressure assembly has two four dimensional pressure sensors, mounted on the opposing front and rear sides of the assembly, so as to be able to measure a twist by the user either clockwise or counter-clockwise and by measuring the pressure as positive or negative along an x-axis or y-axis for both sensors (left and downwards direction is negative, right and upwards is positive). Where both sensors together register a positive (right) relative pressure or negative (left) relative pressure, the cursor movement is in the respective direction. On the other hand when the relative pressures registered differ between the front sensor on one hand and the rear sensor on the other, it is treated as a twist and thus as a click. When the front sensor registers a positive pressure (right) and the rear sensor negative (left), it is a clockwise twist which is interpreted as a right-click. However, if the front sensor registers negative (left) and the rear positive pressure (right), it is a counterclockwise twist which is interpreted as a left-click.

The device may be installed and calibrated (for pressure on the sensors) for the specific user and the ergonomic design may be set to accommodate the specific handicap of the user or the specific limb (left or right hand or foot) being used.

### BRIEF DESCRIPTION OF THE DRAWINGS

FIG. 1 shows a Normal-Look Mouse Design with pressure-based navigation instead of sliding.

FIG. 2 shows an Extended Mouse Design with a full hand grip for users with limited hand and finger muscle control.

FIG. 3 shows the lower mouse plate or pressure sensor assembly for the Extended Mouse Design with four (4) 1-dimensional pressure sensors on the four edges and a twist sensor in the center.

FIG. 4 shows the lower mouse plate or pressure sensor assembly for the Extended Mouse Design with six (6) 2-dimensional pressure sensors on the edges.

FIG. 5 shows the lower mouse plate or pressure sensor assembly for the Extended Mouse Design with two (2) 4-dimensional pressure sensors on the front and back edges.

### DETAILED DESCRIPTION OF THE MIRACLE MOUSE INVENTION

The hand version of the Miracle Mouse invention looks like a normal mouse but instead of having an optical or mechanical element to sense the sliding of device in the four directions, it has electrical pressure sensors on four sides. While the device is still stationary, the user leans his or her hand in the desired direction causing the differential pressure reading to increase in the desired direction. The detailed description is as follows:

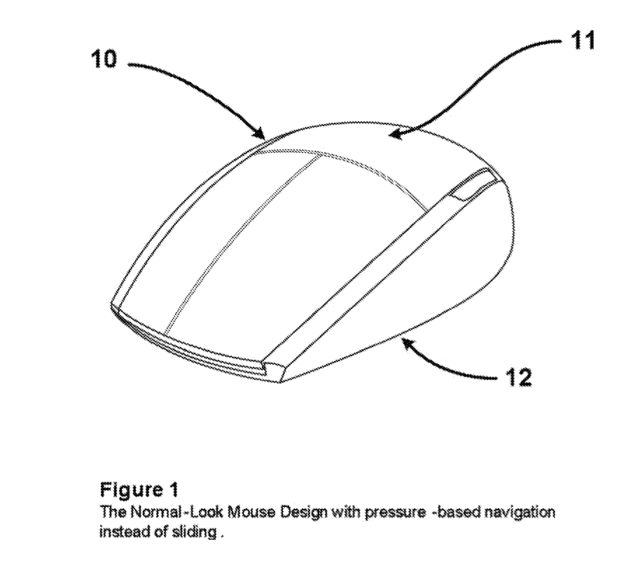

The basic device housing 10 in one version of the device is designed to look like a normal computer mouse 10 as shown in FIG. 1. The surface of the upper component 11 of the device 10 has two buttons 14 for left and right clicks. The upper surface 11 is made off a rubber-feeling material that allows a user to rest his/her hand on it comfortably and with maximum friction to prevent the hand from slipping off. The lower plate 12 of the device 10 has a sticky, non-slippery surface at the bottom so the device 10 stays stationary on the desk top so it does not slide. Another way to prevent the device 10 from sliding on the table is to have an embedded weight insight the device body, or suction cups on the surface. The upper part 11 and the lower part 12 are connected together via pressure sensors joints in a pressure sensor assembly.

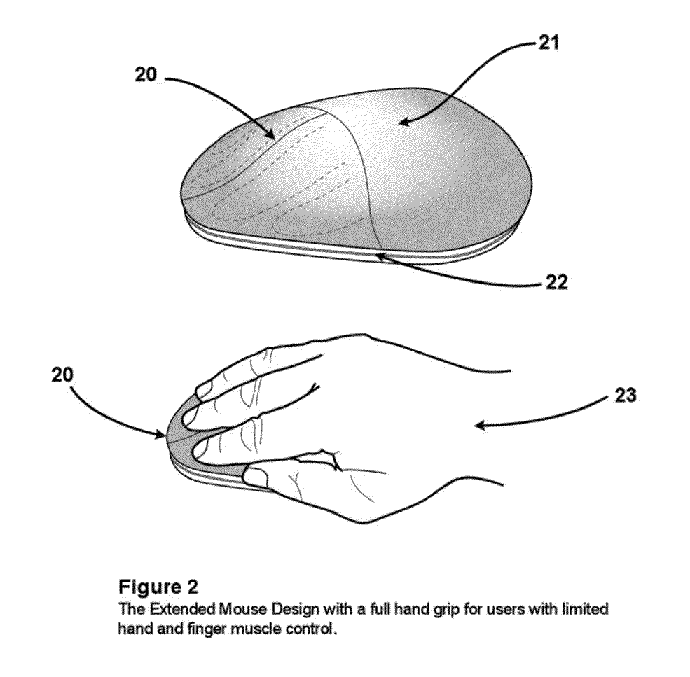

The extended mouse housing 20 in another version of the Miracle Mouse 20 is larger in size and allows the whole hand 23 to rest on it as shown in FIG. 2. The surface of the upper component 21 of the device 20 is built from an appropriate material which is comfortable and soft enough to rest hand or foot for a longer period of time, yet without slipping off. It also has two buttons 24 for left and right clicks. In this ergonomic version of the design, the surface of the upper component 21 of the device 20 may actually resemble the curves of the palm side of the hand 23 and fingers when the hand is at rest in the most comfortable position and orientation. Two different versions can be made for left and right hands. This version is designed especially for users who have medical conditions and cannot navigate their hands and fingers lacking full muscle control. The idea of the upper surface 21 resembling the curves of the hand 23 is so as to have a better grip of the device 20 body, so the user need not actually exert any additional energy to hold onto the device body. The user uses energy only to lean onto the device 10 or twist his hand 23. The grip should be strong enough that the hand does not slip off.

The lower component 12 or 22 is designed with non-slippery cushion at the bottom, which keeps the device 10 or 20 from sliding on the table top unintentionally distorting the relevant pressure readings from the pressure sensors. Also this cushion on the bottom gives the user that further soft and comfortable feeling while his or her hand rests on the device. Other variants use air suction pads or an adhesive layer on the surface to may also be used in some models to help the device stick to the table or desk and prevent it from sliding.

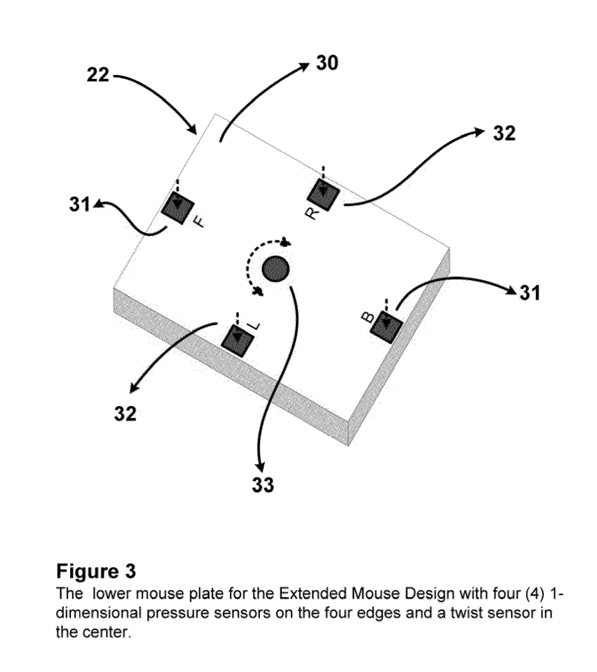

An implementation embodiment of a pressure-based input device is illustrated in FIG. 3, showing the pressure sensor assembly 30 which separates the lower component 22 of the device from the upper component 21 as was shown in FIG. 2. This pressure sensory assembly 30 comprises: four single-dimensional pressure sensors, two of them 31 mounted on the front and rear sides of the device, and the other two 32 mounted on the right and left sides of the device.

A single twist sensor 33 mounted in the middle of the pressure sensor assembly. The two opposing front/rear pressure sensors 31, measure the pressure differential reading to determine the desired direction of motion towards the front or the rear sides of the device, resulting in an up/down cursor motion on the screen. On the other hand, the two opposing left/right pressure measure 32, measure the pressure differential reading to determine the desired direction of motion towards the left or the right sides of the device resulting in a left/right cursor motion on the screen. When the user intends to create a cursor movement action, then he or she must lean his or her hand with minimal effort in the desired direction to increase the differential pressure on one side in reference to its opposing side. The cumulative vector reading of pressure differential on all four sensors 31 and 32, will determine a resultant cursor movement in any desired free direction.

The twist sensor 33 is mounted in the center of the pressure sensor assembly, mechanically connecting the upper body 21 of the device from the lower body 22 allowing a limited single-dimensional vertical axial rotation clockwise or counter-clockwise. Twisting the upper body 21 of the device 20 clockwise or counter-clockwise in reference to the stationary lower component or base 10 without drastically affecting the relative pressures of the four side sensors determines the intent of the user to click right or left respectively.

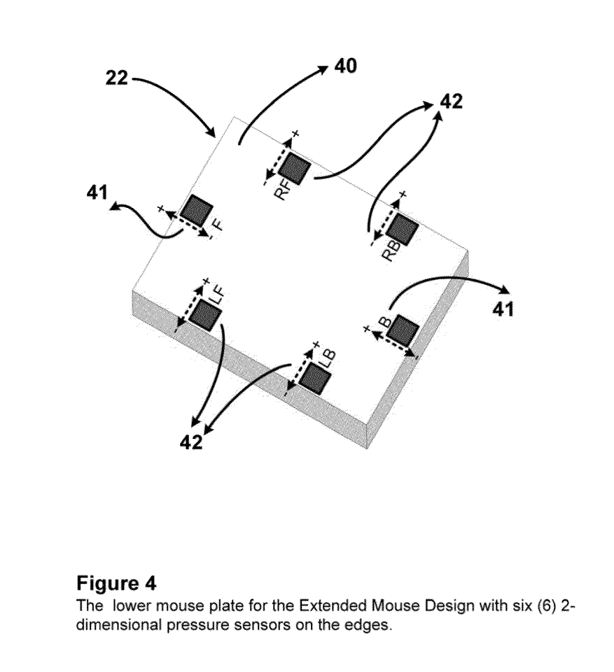

Another implementation embodiment of the pressure sensor assembly 40 is shown in FIG. 4, which connects the lower component 22 of the device of the device to the upper component 21. This pressure sensory system 40 comprises six two-dimensional pressure sensors, two of them 41 mounted on the front and rear sides of the device, and the other four 42 mounted two each on the left and right sides of the device. When the four sensors 42 read negative pressures to the left direction, then the cursor moves to the left (east on the screen). When the four sensors 42 read positive pressures to the right direction then the cursor moves to the right (west on the screen). When either or both sensors 41 reads positive pressure in the forward direction then the cursor moves to front (north on the screen). On the other hand, when either or both sensors 41 reads positive pressure in the backward direction then the cursor moves to back (south on the screen).

When the sensors 42 read opposite pressures between the front and the rear on either or both sides (sensor 42 RF positive and sensor 42 RB negative, or sensor 42 LF positive and sensor 42 LB negative), it is interpreted as a clockwise twist and the device generates the right-click command. When the sensors 42 read opposite pressures between the front and the rear on either or both sides in the opposite direction (sensor 42 RF negative and sensor 42 RB positive, or sensor 42 LF negative and sensor 42 LB positive), it is interpreted as a counter-clockwise twist and the device generates the left-click command.

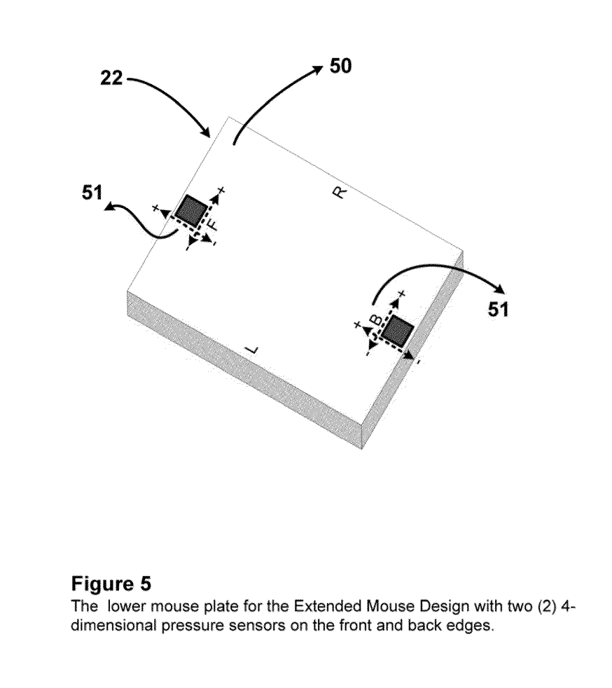

Yet another implementation of the embodiment of the pressure sensor assembly 50 that separates and connects the lower component 22 of the device from the upper component 21 is shown in FIG. 5. This pressure sensor assembly 50 comprises two four-dimensional pressure sensors 51, one of them mounted on the front and the other on the rear. When the two sensors 51 read negative pressures in the left direction then the cursor moves to the left (west on the screen). When the two sensors 51 read positive pressures in the right direction then the cursor moves to the right (east on the screen). When the two sensors 51 read positive pressures in the forward direction then the cursor moves to the front (north on the screen). If the two sensors 51 read negative pressures in the backward direction then the cursor moves to the back (south on the screen). On the other hand, when the two sensors 51 read opposite pressures in the left/right directions, it is interpreted as a twist. In the scenario that sensor 51 F reads positive in the right direction and sensor 51 B negative in the left direction, it is interpreted as a clockwise twist and the device generates the right-click command. However, in the scenario that sensor 51 F reads negative in the left direction and sensor 51 B positive in the right direction, it is interpreted as a counter-clockwise twist and the device generates the right-click command.

Various styles and sizes of both versions of the device 10 and 20 could be made available for a variety of end users and their specific needs. The operation of the device can be further improved with the use of initialization and calibration software. At the initial setup and calibration, the sensors takes pressure readings on all four sides of the device and register them as the normal idle situation which compensates for the hand or foot weight itself and the uneven relative pressure reading on any of the four sides for each individual user.

The entire above design details for the hand version of the Miracle Mouse can be extended and applied for a foot-based device for those individuals in need, who do not have enough muscle control on their hands but they are able to achieve the same by their feet.

I claim:

1. A computer cursor input device based on sensing hand or foot weight pressures on the body of the device comprising:
an upper component consisting of a rubber-feeling material allowing a user of the device to rest their hand or foot on it comfortably, and allowing for maximum friction to prevent the hand or foot from slipping off;
a lower component, having a stationary and non-slippery means spanning its bottom surface so as to prevent the device from sliding and to maintain it stationary on a desk top;
Wherein the upper and lower components are mechanically connected together by means of a pressure sensor assembly having a plurality of pressure sensors which provide a reading of the pressure to determine an intended direction of movement for a cursor on a field of display of a computer.

2. The computer cursor input device of claim 1, wherein the movement for a cursor on a field of display of a computer comprises pointing, clicking, selection, scrolling and sensing positional input along the computer's display.

3. The computer cursor input device of claim 1, wherein
the upper component of the device is designed with its surface to accommodate the curves and a plurality of digits of the contacting side of the hand or foot of the user when the hand or foot is at rest and engaged with the upper component in a maximally comfortable position and orientation for firm grip and ease of use; and
the lower component is further expanded at the bottom so the hand or foot of the user can rest on it in its entirety, particularly at its rear joint and sides;
wherein the device ergonomically shaped, wherein a minimum expending of the users kinetic energy is required to engage with the device where the user has a medical condition and is unable to navigate their hand or foot and its digits with full muscle control. and wherein that kinetic energy is solely used to apply positional and directional pressure upon the upper component of the device.

4. The computer cursor input device of claim 1, wherein the upper and lower components of the device assume a standard shape of standard computer mouse, where the upper component has both a left button and a right button.

5. The computer cursor input device of claim 1. wherein the stationary and non-slippery means spanning the bottom surface of the lower component of the device is implemented from the group comprising a non-slippery cushion material, an adhesive outer surface, a plurality of air suction pads, and an embedded weight, with which to hold the lower component better to the desk surface.

6. The computer cursor input device of claim 1, wherein the pressure sensor assembly further comprises:
four single-dimensional pressure sensors, two of them mounted on the opposing front and rear sides of the assembly, and the other MO mounted on the opposing right and left sides of the assembly;
a single twist sensor mounted in the middle of the assembly to measure a twist by the user;
wherein the two opposing front and rear side mounted pressure sensors measure the pressure differential reading to determine the desired input direction and speed towards the front or rear sides of the device;
wherein the two opposing right and left side mounted pressure sensors measure the pressure differential reading to determine the desired input direction and speed towards the right or left sides of the device;
wherein the user creates an intended cursor movement action by leaning their hands in the desired direction with minimal effort in order to increase the pressure differential on one side of the device in reference to the opposing side;
wherein a cumulative vector reading of pressure differential on all four sensors, will determine a resultant cursor movement in any desired free direction;
wherein the pressure sensor assembly which mechanically connects the upper and lower components using an axial member which limits the twist to only vertical axial rotation of the upper component clockwise or counter-clockwise in relation to the lower component, the twist sensor mounted in the center of the assembly to measure that vertical axial rotation; and
wherein twisting the upper component clockwise or counter-clockwise in relation to the lower component without drastically affecting the pressure differential readings of the four single-dimensional sensors determines the intent of the user to click right or left respectively.

7. The computer cursor input device of claim 1, wherein the pressure sensor assembly further comprises:
six two-dimensional pressure sensors, two of them mounted on the opposing front and rear sides if the assembly, and the other four mounted two each on the opposing right and left sides of the assembly;
wherein the two opposing front and rear side mounted pressure sensors measure the pressure differential reading to determine the desired input direction and speed towards the front or rear sides of the device;
wherein the opposing two right and two left side mounted pressure sensors measure the pressure differential reading as overall positive to the right or overall negative to the left to determine the desired input direction and speed towards the right or left sides of the device such that all four side sensors register positive when the user pushes to the right and all four register negative when the user pushes to the left;
wherein the user creates an intended curser movement action by leaning their hands in the desired direction with minimal effort in order to increase the pressure differential on one side of the device in reference to the opposing side;
wherein a cumulative vector reading of pressure differential on all six sensors will determine a resultant cursor movement in any desired free direction;
wherein when the movement action by the user is a clockwise twist, the opposing front right and front left side mounted pressure sensors measure the pressure differential reading as overall positive to the right and the opposing rear right and rear left side mounted pressure sensors measure the pressure differential reading as overall negative to the left, and is interpreted as a right-click of the device;
wherein when the movement action by the user is a counterclockwise twist, the opposing front right and front left side mounted pressure sensors measure the pressure differential reading as overall negative to the left and the opposing rear right and rear left side mounted pressure sensors measure the pressure differential reading as overall positive to the right, and is interpreted as a left-click of the device.

8. The computer cursor input device of claim 1, wherein the pressure sensor assembly further comprises:
two four-dimensional pressure sensors, mounted on the opposing front and rear sides of the assembly;
wherein the two opposing front and rear side mounted pressure sensors measure the pressure differential reading forwards or backwards to determine the desired input direction and speed towards the front or rear sides of the device;
wherein the two opposing front and rear side mounted pressure sensors measure the pressure differential reading from side-to-side to determine the desired input direction and speed towards the right or left sides of the device;
wherein the user creates an intended cursor movement action by leaning their hands in the desired direction with minimal effort in order to increase the pressure differential on one side of the device in reference to the opposing side;
wherein a cumulative vector reading of pressure differential on both sensors, will determine a resultant cursor movement in any desired free direction;
wherein when the movement action by the user is a clockwise twist, the opposing front and rear mounted pressure sensors measure the pressure differential reading to register as overall positive to the right at the front sensor and an overall negative to the left at the rear sensor, which is interpreted as a right-click of the device;
wherein when the movement action by the user is a counterclockwise twist, the opposing front and rear mounted pressure sensors measure the pressure differential reading to register as overall negative to the left at the front sensor and an overall positive to the right at the rear sensor, which is interpreted as a left-click of the device.

9. The computer cursor input device of claim 1, designed and manufactured for a variety of end users and their specific needs, including the particular hand or foot used and the desired size.

10. The computer cursor input device of claim 1, further comprising initial setup software utilities to help the user to calibrate the sensors readings for their specific individual needs, to compensate for the weight of the hand or foot being used, as well as for an uneven relative reading of pressure on all four sides of the device for the user.

11. A method of movement for a cursor on a field of display of a computer by means of a computer cursor input device comprising the steps of:
sensing hand or foot weight pressures on an upper component of the device consisting of a rubber-feeling material allowing a user of the device to rest their hand or foot on it comfortably, and allowing for maximum friction to prevent the hand or foot from slipping off;
securing the device, to a desk top to render it stationary by means of a lower component, having a stationary and non-slippery means spanning its bottom surface, which maximizes friction and prevents the device from sliding;
reading the pressure exerted by the user by means of a pressure sensor assembly having a plurality of pressure sensors, in order to determine an intended direction of movement for the cursor on a field of display of a computer;
wherein the upper and lower components are mechanically connected together by means of the pressure sensor assembly.

12. The method of claim 11, wherein the movement of the cursor on the field of display of a computer comprises pointing, clicking, selection, scrolling and sensing positional input along computer.

13. The method of claim 11, further comprising the steps of:
ergonomically designing the upper component of the device with its surface to accommodate the curves and a plurality of digits of the contacting side of the hand or foot of the user when at rest;
engaging the hand or foot of the user with the upper component in a maximally comfortable position and orientation for firm grip and ease of use;
applying positional and directional pressure upon the upper component of the device with a minimum expending of the user's kinetic energy;
expanding the lower component further at the bottom;
resting the hand or foot of the user on the expanded lower component in its entirety, particularly at its rear joint and sides;
wherein the device is optimally ergonomically shaped, and the user has a medical condition and is unable to navigate their hand or foot and its digits with full muscle control.

14. The method of claim 11, wherein the step of securing the device to a desk top to render it stationary by means of the lower component, is implemented such that the stationary and non-slippery means is selected from the group comprising a non-slippery cushion material, an adhesive outer surface, a plurality of air suction pads, and an embedded weight, with which to hold the lower component better to the desk surface.,

15. The method of claim 11, further comprising the steps of:
mounting four single-dimensional pressure sensors on the pressure sensor assembly, two of them on the opposing front and rear sides of the assembly, and the other two on the opposing right and left sides of the assembly;
mounting a single twist sensor in the middle of the assembly to measure a twist by the user;
determining the desired input direction and speed towards the front or rear sides of the device by measuring the pressure differential reading on each of the two opposing front and rear side mounted pressure sensors;
determining the desired input direction and speed towards the right or left sides of the device by measuring the pressure differential reading on each of the two opposing right and left side mounted pressure sensors;
creating an intended cursor movement action by the user leaning their hands in the desired direction with minimal effort in order to increase the pressure differential on one side of the device in reference to the opposing side;
determining a resultant cursor movement in any desired free direction by reading the cumulative vector of pressure differential on all four sensors;
mechanically connecting the upper and lower components using an axial member which permeates the pressure sensor assembly limiting the twist to only vertical axial rotation of the upper component clockwise or counter-clockwise in relation to the lower component;
mounting the twist sensor at the center of the pressure sensor assembly to measure that vertical axial rotation; and
determining an intent of the user to click right or left respectively by twisting the upper component clockwise of counter-clockwise in relation to the lower component without drastically affecting the pressure differential readings of the four single-dimensional sensors.

16. The method of claim 11, further comprising the steps of:
mounting six two-dimensional pressure sensors pressure sensors on the pressure sensor assembly, two of them on the opposing front and rear sides of the assembly, and the other four mounted two each on the opposing right and left sides of the assembly;
determining the desired input direction and speed towards the front or rear sides of the device by measuring the pressure differential reading on each of the two opposing front and rear side mounted pressure sensors;
determining the desired input direction and speed towards the right or left sides of the device by measuring the pressure differential reading on each of the two opposing right and left side mounted pressure sensors as overall positive to the right or overall negative to the left such that all four side sensors register positive when the user pushes to the right and all four register negative when the user pushes to the left;
creating an intended cursor movement action by the user leaning their hands in the desired direction with minimal effort in order to increase the pressure differential on one side of the device in reference to the opposing side;
determining a resultant cursor movement in any desired free direction by reading the cumulative vector of pressure differential on all six sensors;
interpreting as a right-click of the device by the user when their movement action is a clockwise twist, by measuring the pressure differential reading on the opposing front right and front left side mounted pressure sensors as overall positive to the right and on the opposing rear right and rear left side mounted pressure sensors as overall negative to the left; and
interpreting left-click of the device by the user when their movement action is a counterclockwise twist, by measuring the pressure reading on the opposing front right and front left side mounted pressure sensors as overall negative to the left and on the opposing rear right and rear left side mounted pressure sensors as overall positive to the right.

17. The method of claim 11, further comprising the steps of:
mounting two four-dimensional pressure sensors pressure sensors on the pressure sensor assembly, on the opposing front and rear sides of the assembly;
determining the desired input direction and speed towards the front or rear sides of the device by measuring the pressure differential reading on each of the two opposing front and rear side mounted pressure sensors;
determining the desired input direction and speed towards the left or right sides of the device by measuring the pressure differential reading on both of the two opposing front and rear side mounted pressure sensors towards either the left or the right;
creating an intended cursor movement action by the user leaning their hands in the desired direction with minimal effort in order to increase the pressure differential on one side of the device in reference to the opposing side;
determining a resultant cursor movement in any desired free direction by reading the cumulative vector of pressure differential on both sensors;
interpreting as a right-click of the device by the user when their movement action is a clockwise twist, by measuring the pressure differential reading on the opposing front and rear side mounted pressure sensors as overall positive to the right on the front and as overall negative to the left on the rear; and
interpreting as a left-click of the device by the user when their movement action is a counterclockwise twist, by measuring the pressure differential reading on the opposing front and rear side mounted pressure sensors as overall negative to the left on the front and as overall positive to the right on the rear.

18. The method of claim 11, further comprising the steps of:
designing and manufacturing the computer cursor input device for a variety of end users and their specific needs, including for the particular hand or foot used and the desired size.

19. The method of claim 11, further comprising the steps of:
initially setting up the device by means of software utilities;
calibrating the sensors' readings by means of the software utilities, for the user's specific individual needs, to compensate for the weight of the hand or foot being used, as well as for an uneven relative reading of pressure on all four sides of the device for the user.
